(19) United States
(12) Patent Application Publication
(10) Pub. No.: US 2012/0243256 A1
(43) Pub. Date: Sep. 27, 2012

(54) LED LIGHTING DEVICE WITH LIGHT GUIDE PLATE

(75) Inventors: Ke-chin Lee, Taiwan (CN); Shu-Cheng Hsu, Taiwan (CN)

(73) Assignee: Zhongshan Weiqiang Technology Co., LTD, Guangdong (CN)

(21) Appl. No.: 13/426,107

(22) Filed: Mar. 21, 2012

(30) Foreign Application Priority Data
Mar. 21, 2011 (CN) 201110067747.5

(51) Int. Cl. F21V 7/04

(52) U.S. Cl. 362/609

(57) ABSTRACT

A light guide plate includes a lateral side through which light enters and a front side through which light exits. A phosphor is coated on the lateral side. A light source includes a plurality of light emitting diodes (LEDs) having wavelengths of 230-520 nanometers (nm). The LEDs are mounted proximate to the lateral side and corresponding to, but separated from, the phosphor. A reflector includes a reflective surface and is mounted on a back side of the light guide plate with the reflective surface facing the light guide plate. A frame fixes the light guide plate, the light source, and the reflector. Colors of the phosphor and the light source are complementary. The phosphor absorbs light from the light source to transition into an excited state. The light guide plate outputs light from the light source and the phosphor through the front side.

### FIELD

The present invention relates to a light emitting diode (LED) lighting device and more particularly to an LED lighting device with a light guide plate.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Light guide plates are designed to convert point and linear light sources to area light sources. Due to various benefits provided by light guide plates, such as ultra-thin design, light weight, lighting uniformity, energy efficiency, and high stability, light guide plates have been widely used in the areas of displaying and lighting.

Generally, the light source of lighting devices with light guide plates is light emitting diodes (LEDs). Light from the light source is directed by and transmitted within the light guide plate and is eventually output from the light emitting surface of the light guide plate. Due to the structural characteristics of light guide plates and lighting devices, lighting devices with light guide plates usually have a slim shape. The light output from lighting devices with light guide plates is quite even, and there are few dark areas. Thus, lighting devices with light guide plates could satisfy the requirements for daily use of most products. However, in the high-end lighting fields, especially for displaying and lighting, where the super slim design, high precision, high efficiency, and high uniformity of lighting are required, LED light guide plates may have some drawbacks.

In the high-end lighting fields, where much stricter standards are in place for light guide plates and LED light sources, when selecting a LED lighting device with light guide plate for a specific application, it is required to take the color temperature related properties of the LED into account. It is also required to select the LEDs by binning and to take into account the color, non-deformability, and lifetime of the light guide plate, for example, in order to assure that the requirements are satisfied. Thus, a large proportion of raw materials are not adoptable, and stricter requirements are applied on production. Consequently, production costs are increased.

High-end lighting is sensitive to color temperature and energy utilization efficiency. In practice with LEDs, however, control of color temperature is usually accomplished by color mixing of the LEDs. This leads to higher requirements on material selection. Due to problems associated with diffraction efficiency, the final products may not satisfy color saturation expectations. In addition, an energy loss may exist due to light of the LEDs being reflected by air before entering the light guide plate. If this energy loss can be reduced, the energy utilization efficiency can be improved.

Color temperature control with LEDs may additionally or alternatively accomplished by packaging LEDs and phosphors together and mixing the light of the LEDs and the excited phosphors. During operation of the LEDs, and especially during operation of the LEDs for an extended period, increasing temperature may negatively impact the phosphors. For example, operation of the LEDs for an extended period may cause color temperature drift and brightness degradation. This may lead to unstable color temperature and negatively impact the eventual lighting effect.

LEDs are a type of point light source. In an LED lamp with a light guide plate, LEDs are usually evenly distributed on one side of the light guide plate, and some dark bands exist among the LEDs. To eliminate the dark bands, there is a need to reduce the spacing of the LEDs. Thus, for an equal length, more LEDs are required. However, more LEDs means higher cost and, for some portable devices, more LEDs increases battery load. Additionally, adding a shade for absorbing light at the front side of the light guide plate and/or for hiding the dark bands will cause light energy loss. For high-end lighting products, the energy loss of the shade may outweigh the shade's benefits.

In order to effectively utilize the light energy of the LEDs, the entire thickness of the light guide plate is greater than the diameter of the LEDs. This may effectively utilize the energy of the lateral light of the LEDs and avoid light energy loss. However, this may impact the thickness control of the light guide plate. Thus, there is a need to effectively utilize the lateral light of the LEDs as well as to decrease the thickness of the light guide plate.

The energy of the light transmitted through the light guide plate progressively decreases over distance. This leads to unevenness of lighting.

More specifically, the part of the light guide plate that is closer to the light source is brighter than the part of the light guide plate that is further from the light source. Thus, there is a need to even the lighting.

### SUMMARY

An objective of the present invention is to provide an LED lighting device with a light guide plate, to solve the problems of high cost, energy loss, unstable color temperature, insufficient color saturation, excessive thickness, uneven lighting, etc.

An LED lighting device with a light guide plate includes a light guide plate. Light travels into the light guide plate through a lateral side of the light guide plate. Light travels out of the light guide plate through a front side of the light guide plate. A phosphor is coated on the lateral side of the light guide plate. A light source includes one or more light emitting diodes (LEDs) having a wavelength of 230-520 nanometers (nm). The light source is mounted in close proximity to the lateral side of the light guide plate and corresponds to but is separated from the phosphor. A reflector is mounted on a back side of the light guide plate and includes a reflective surface that faces the light guide plate. A frame is provided for fixing the light guide plate, the light source, and the reflector. The colors of the phosphor and the light source are complementary. The phosphor is able to absorb light from the light source to jump into an excited state as to allow the light guide plate to receive the light from the light source and phosphor and output the mixed light through the front side thereof in conjunction with the reflector.

The phosphor may be a tricolor phosphor or a yellow phosphor. The light guide plate is provided with dot patterns on the back side thereof. The dimension and density of the dot patterns are proportional to the distance of the dot patterns from the light source. Dot patterns with smaller dimension or density are arranged closer to the light source. Dot patterns with larger dimension or density are arranged further from the light source. The spacing of the dot patterns is inversely proportional to the distance of the dot patterns from the light source. The dimension and density of the dot patterns are proportional to the size of the vector of the dot patterns from the light source. The light guide plate is provided with the dot patterns on the front side thereof. The light guide plate is provided with the dot patterns on the lateral side thereof on which the phosphor is coated.

The LED lighting device may include an optical film that is a diffuser and that is attached to the front side of the light guide plate. The LED lighting device may include an optical film that is a composite material of the diffuser and a brightness enhancement film that is attached to the front side of the light guide plate.

The light guide plate may be a rectangular, circular, or elliptical shape, and the frame may be in a matched annular shape. The light source is arranged on the inner wall of the frame.

The light guide plate may be a rectangular, circular, or elliptical ring shape. The frame may include an inner frame and an outer frame. The outer frame is in an annular shape matched with the periphery of the light guide plate and encloses the periphery of the outer frame. The inner frame is in an annular shape matched with the inner edge of the light guide plate and encloses the inner edge of the light guide plate. The phosphor is coated on the outer and/or inner side of the light guide plate, and the light source is fixed on the outer and/or inner frame.

On the external of the frame, heat dissipation fins may be provided in in close proximity to the light sources.

The present application may provide one or more of the following advantages: as the phosphor is arranged on the part of the light guide plate through which the light goes in, the light from the lateral side of the LEDs could be used to excite the phosphor, and thus is fully utilized, without considering whether the thickness of the light guide plate stratifies the requirements of allowing the lateral light to go in the light guide plate, the light guide plate could be made with a small thickness, even equal to the diameter of the LEDs. Resulting from above, the present application may enable a significant reduction in the thickness of the light guide plate, save the materials, and/or enable a compact design.

The present application may also enable effective utilization of the front and lateral light of the LEDs to excite the phosphor, so as to increase the luminous flux of the light guide plate, and avoid the light loss caused by the excessive lighting angle of the lateral light and the light counteraction.

As the ultimate color temperature is determined by the light of light source and the light of the phosphor excited on the lateral side of the light guide plate, in terms of color temperature adjustment, the color temperature of the LED, for example, and the selection of the phosphor are focused on. Thus, in general, it is only required to simply change the color of the phosphor, without adjusting the light source or the LED binning selection. Production is thus significantly simplified, and packaging the phosphor within the light source is no longer necessary. Cost for packaging is accordingly reduced, even if the selection of the light guide plate is relatively unchanged, and the costs of the materials and production are further reduced.

The light source and the phosphor are not packaged together. Thus, during operation, the impact of the heat generated by the LEDs on the phosphor is minimized. Color temperature offset and brightness degradation may therefore be avoided. In addition, if packaging the phosphor within the light source, the mixture of four even more colors is easily achieved, leading to better light diffraction and color saturation.

Directly coating the phosphor on the part of the light guide plate through which the light enters, the angle of the light from the light source entering the light guide plate will be enlarged due to the refraction, reflection, or second refraction by the phosphor. Also, in conjunction with the light of the excited phosphor, the mixed light entering the light guide plate is more evenly distributed, no dark band occurs on the lateral side of the light guide plate, and a shade is not required to shade the lateral sides of the light guide plate. The energy loss may therefore be reduced while providing suitable lighting effects.

A variety of color combinations of the light source, the phosphor, and the light guide plate can achieve higher color rendering performance. For example, a blue light source, a yellow phosphor, and a reddish light guide plate can be used in combination to achieve higher color rendering performance.

The dot patterns and the different formations, combinations and arrangements thereof can be used to provide even lighting.

The present application therefore provides great advantages in terms of cost, technology, and practical performance, even with the same or cheaper materials.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic view of an example embodiment according to the present application;

FIG. 2 is a schematic view showing how the light from the light source excites the phosphor to emit light;

FIG. 3 is a schematic view showing how the light goes into the phosphor and light guide plate;

FIG. 4 is a diagram showing the linear relationship between the dimension of the dot patterns and the light energy in the light guide plate;

FIG. 5 is a diagram showing the linear relationship between the density of the dot patterns and the light energy in the light guide plate;

FIG. 6 is a diagram showing the linear relationship between the spacing of the dot patterns and the light energy in the light guide plate;

FIG. 7 is a schematic view of the light guide plate in an embodiment of the present invention;

FIG. 8 is a schematic view showing the distribution of the dot patterns of the light guide plate in an embodiment;

FIG. 9 is a schematic view showing the blocks of the dot patterns on the light guide plate in an embodiment;

FIG. 9 is a schematic view showing the blocks of the dot patterns on the light guide plate in an embodiment;

FIG. 11 is a schematic view of the shape of the dot patterns in an embodiment;

FIG. 12 is a schematic view of the shape of the dot patterns in an embodiment;

FIG. 13 is a schematic view of the shape of the dot patterns in an embodiment;

FIG. 14 is a schematic view of the shape of the dot patterns in an embodiment;

FIG. 15 is a schematic view of the shape of the dot patterns in an embodiment;

FIG. 16 is a schematic view of the shape of the dot patterns in an embodiment;

FIG. 17 is a schematic view of the distribution of the dot patterns on the light guide plate in an embodiment;

FIG. 18 is a schematic view of the distribution of the dot patterns on the light guide plate in an embodiment;

FIG. 19 is a schematic view of the back side of an embodiment;

FIG. 20 is a schematic view of the lateral side of an embodiment;

FIG. 21 is a schematic view of the back side of an embodiment;

FIG. 22 is a schematic view of the front side of an embodiment;

FIG. 23 is a schematic view of the lateral side of an embodiment;

FIG. 24 is a schematic view of the back side of an embodiment; and

FIG. 25 is a schematic view of the front side of an embodiment.

### DETAILED DESCRIPTION

As shown by FIG. 1, an LED lighting device with a light guide plate includes a frame 1, a plurality of light sources 2, a light guide plate 3, and a phosphor 4. The frame 1 is an integral positioning structure. The light sources 2 are light emitting diodes (LEDs), which are fixed on the inner sidewalls of the frame 1 via a PCB or support.

The light guide plate 3 is fixed by the frame 1 in a clamping way. The light guide plate 3 may be in a flat plate or a wedged-shaped plate, according to actual needs. For example, a flat plate may be used for decoration or lighting, or a wedge-shaped plate may be used in backlight modules for notebook computers, mobile phones, and other types of devices.

On one or more lateral sides of the light guide plate 3, the phosphor 4 is coated to ensure that the light emitted by the light sources 2 toward the light guide plate 2 first falls on the phosphor 4. Thus, after absorbing the light from the light sources 2, the phosphor 4 is excited to jump into an excited state and emit light.

The light from the phosphor 4 will be mixed with the light from the light sources 2. As the light sources 2 and light guide plate 3 are separated by the phosphor 4, the light guide plate 3 receives the mixed light. It should be noted that the phosphor 4 is separated from the light sources 2. In other words, the phosphor 4 and light sources 2 (LEDs) are not packaged together.

A reflector 6 is arranged on the backside of the light guide plate 3, and fixed by the frame 1 or adhered to the backside of the light guide plate 3. The reflector 6 is used to reflect the light within the light device, for example, to increase the overall efficiency of the lighting device.

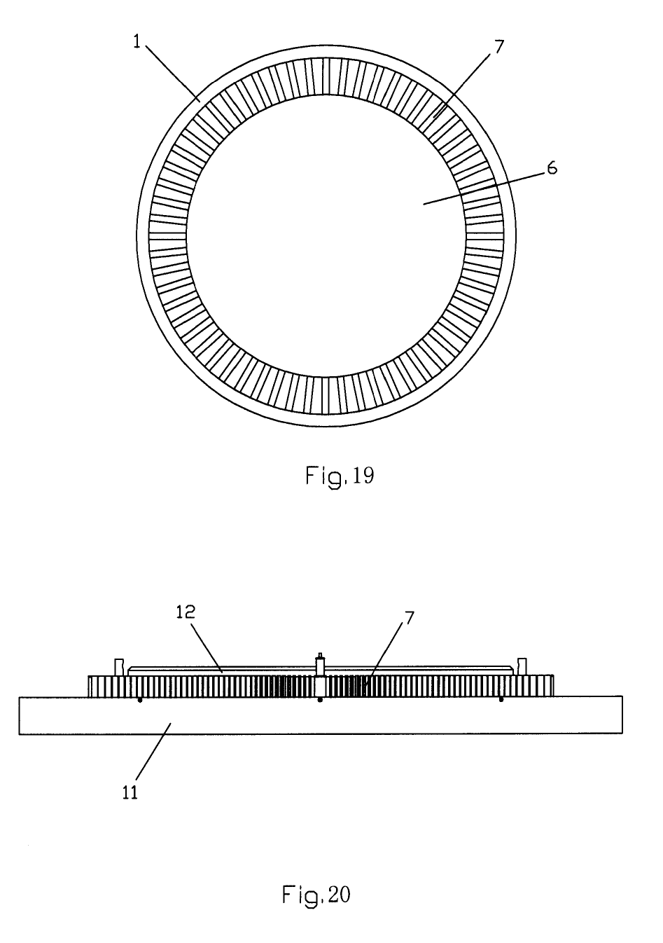

In an embodiment, the light guide plate 3 may have a rectangular plate shape, circular plate shape, elliptical plate shape, or another suitable shape. It is matched with the light guide plate 3 in shape, and correspondingly the frame 1 has an annular shape matched with the peripheral shape of the light guide plate 3. In order to enhance the heat dissipation performance of the lamp, a plurality of heat dissipation fins 7 are disposed on the external of the frame 1 in close proximity to the light sources 2 to allow the heat generated by the light sources 2 during operation to be conducted to the heat dissipation fins 7 and dissipated to the surrounding air, as shown by FIG. 19.

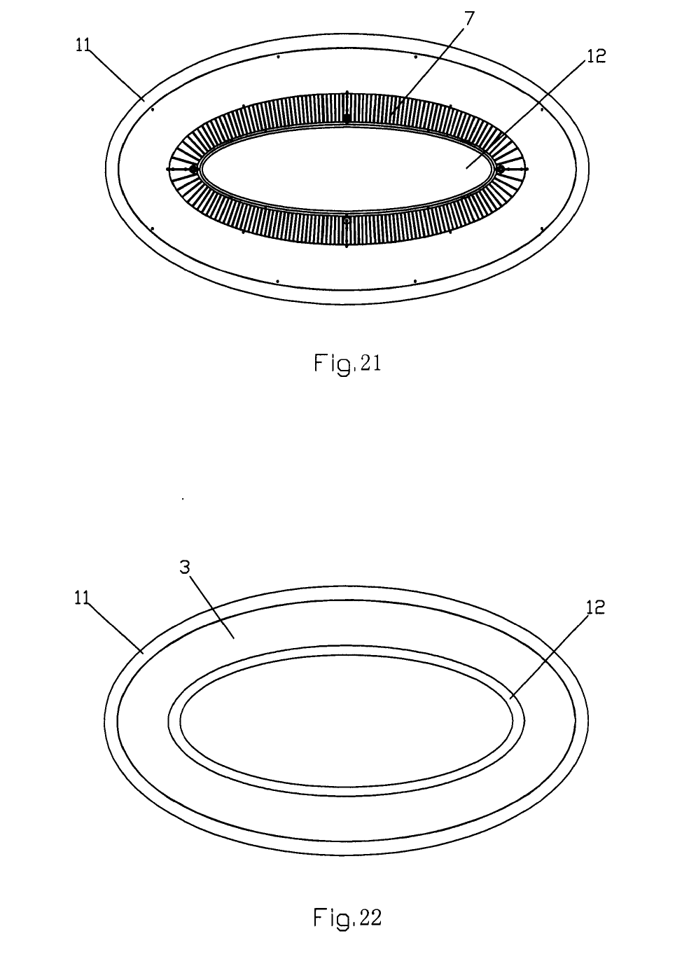

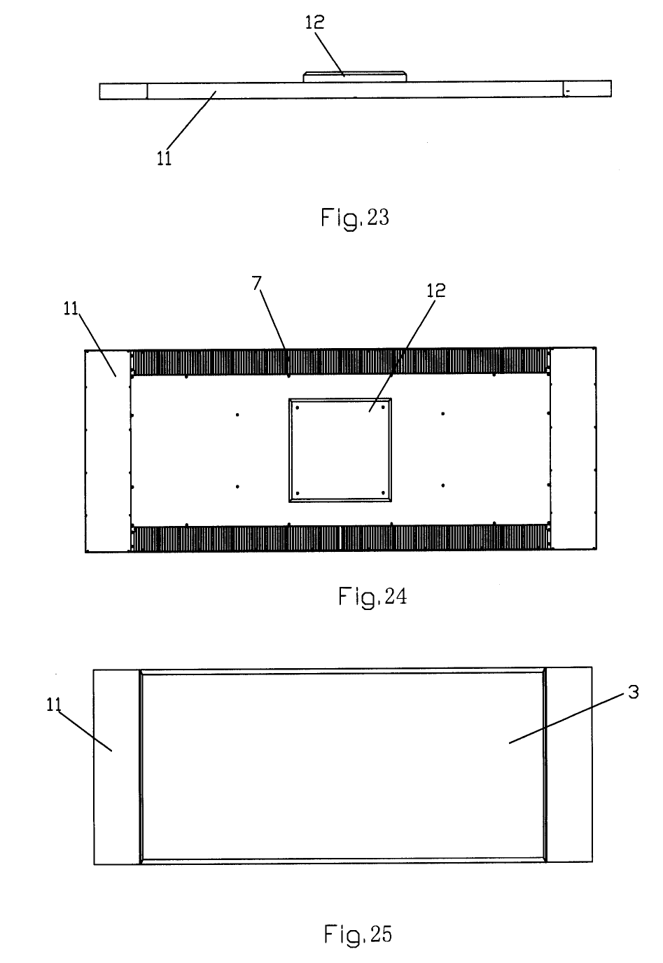

The light guide plate 3 may have a circular or elliptically ring shape, as shown in FIGS. 20, 21 and 22, or have a rectangular ring shape, as shown in FIGS. 23, 24, and 25. In order to match with the light guide plate 3, the frame 1 consists of an outer frame 11 and an inner frame 12. The outer frame 11 is configured in a ring shape to match with the outer edge of the light guide plate 3, and thus to enclose the outer edge of the light guide plate 3. The inner frame 12 is configured in a ring shape to match with the inner edge of the light guide plate 3 and thus to enclose the inner edge of the light guide plate 3.

The phosphor 4 may be coated on the inner or/and outer walls of the light guide plate 3. Accordingly, the light sources 2 could be arranged on the inner or outer sides of the light guide plate 3, corresponding to the position of the phosphor 4, and fixed by the outer frame 11 or inner frame 12. However, the structure may vary according to actual needs. On the outer surfaces of the outer frame 11 and inner frame 12, the heat dissipation pins 7 are arranged in close proximity to the light sources 2 to allow the heat generated by the light sources 2 during operation to be conducted to the heat dissipation pins 7 and dissipated into the surrounding air.

In the optical design of the present application, the following configurations can be adopted: (1) an optical film 5 may be arranged on the front side of the light guide plate 3, the mixed light received by the light guide plate 3 goes through and is diffused by the optical film 5, wherein the optical film 5 may be made of the light-diffuser film materials to make the light more even; (2) a composite material of the diffuser and BEF (Brightness Enhancement Film) may be adopted to achieve the best effect of brightness enhancement and light homogenization; (3) of course, without any optical films, for cost reduction, the similar effects of light homogenization can also be achieved by the structure according to the present application.

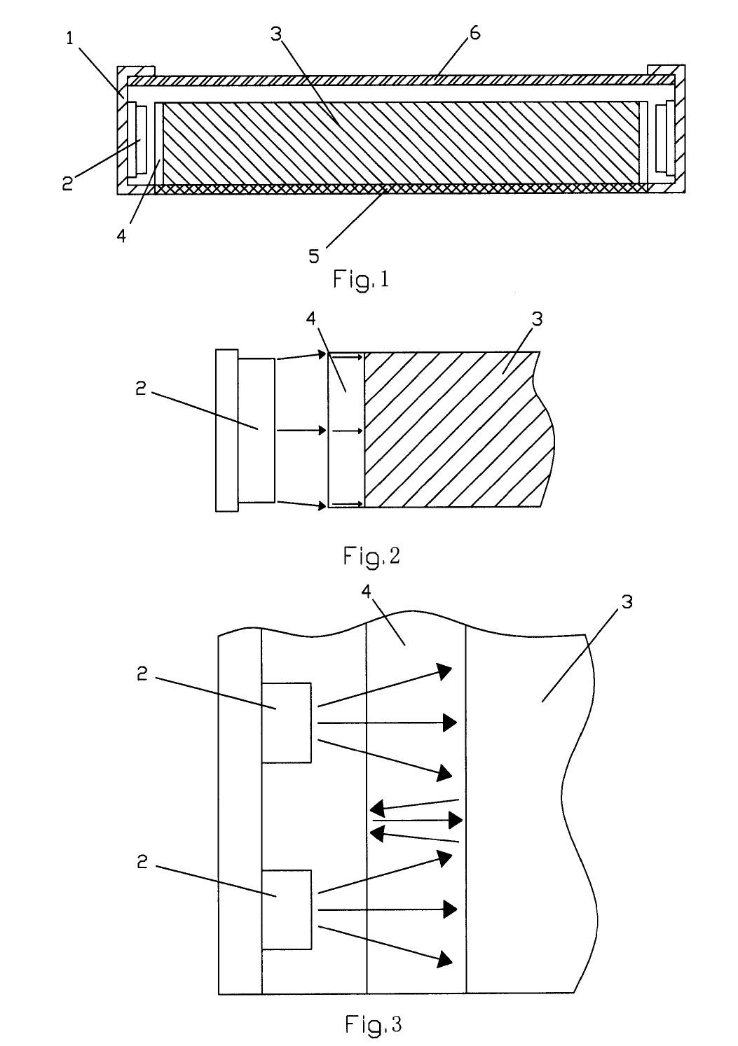

In the embodiments of the present application, the distance between the light sources 2 and the phosphor 4 is minimized to reduce the loss of the light energy and for the best lighting effects. As shown by FIG. 2, the light from the light sources 2 can be used to excite the phosphor 4 coated on the lateral side of the light guide plate 3, and the lateral light of the light sources 2 can be effectively utilized the without considering whether the lateral light goes into the light guide plate 3. Thus, the thickness of the light guide plate 3 can be minimized, even to the extent that the thickness is equal to the diameter of the LEDs. Thus, problems associated with the thickness of the light guide plate 3 can be avoided, such as in fields where higher precision requirements are posed on the dimension, light energy, etc.

In addition, as shown by FIG. 3, for the lateral light of which incident angle is larger than the full reflection angle of the light guide plate 3, after reflected back to the phosphor 3, the light is reflected within the phosphor 4 twice or more times for exciting the phosphor 4, and goes into the light guide plate 3 again. This helps reduce the light loss and prevent the dark bands between every two LEDs from occurring. Briefly stated, this evens the light and reduces energy loss.

The light sources 2 may be LEDs of various colors. As the LEDs are no longer required to be packaged with the phosphor 4, the heat generated by the LEDs during operation will not affect the phosphor 4. Consequently, the color temperature offset and brightness degradation of the phosphor 4 due to the heat may be reduced or eliminated.

Moreover, color temperature control of the final light is shifted from the color temperature control of the light sources 2 to the common color temperature control of the light sources 2 and the phosphor 4. This may simplify making an adjustment to the color temperature. A desired color temperature can be achieved by adjusting the technical parameters of the phosphor 4. This provides technological and cost benefits.

The standard for material selection of the light guide plate 3 is further lowered. Color temperature and energy of the final light are generally determined by the quality of the light guide plate per se, usually the yellowish low quality light guide plates are not applicable, otherwise the final lighting effect will be impaired, and thus leading to higher costs. However, according to the present application, the color temperature of the light guide plate 3 can be taken into account in light mixing. Therefore, cheaper light guide plates could be used, and cost can be reduced.

Better lighting performance can be provided in several ways. For example, in an example embodiment, the light sources 2 may be the blue LEDs with wavelength of 450-520 nanometers (nm), purple LEDs with wavelength of 400-450 nm, or ultraviolet (UV) LEDs with wavelength of 230-400 nm. The color of the phosphor 4 is selected to be complementary with the color of the light sources 2, for example, yellow. Excited by the complementary light from the LEDs, the light from the phosphor 4 is mixed with the original light from the LEDs to generate the final white light.

In addition, to improve color rendering performance, the phosphor 4 can include one or more phosphor materials with different colors. For example, a yellow phosphor 4 may be mixed with a red color to provide a reddish light guide plate 3. In this manner, light with color rendering index of 90 or higher is achieved.

The light sources 2 may be the blue LEDs or purple (UV) LEDs, cooperating with a RGB (Red, Green, and Blue) phosphor 4, and the light from the light sources 2 and the phosphor 4 is combined into white light. This may provide suitable color rendering performance. The light efficiency deficiency of purple LEDs can be solved by sealing and fixing the LEDs in the frame 2. This may reduce energy consumption while providing a suitable illumination level.

Of course, there are still many others embodiments which flow from the present application. For example, if not considering the packaging cost of the light sources 2 per se, LEDs packaged with the phosphor material can be used, cooperating with the phosphor 4, to achieve the light mixing of four or more colors. This may provide suitable light rendering performance.

In an embodiment, the light guide plate 3 is provided with a plurality of dot patterns 31 on the backside thereof. The dot patterns 31 may be formed by etching, V-cutting, electroforming, sand blasting, or silk screening. An example of the dot patterns 31 with a suitable lighting effect will be described herein.

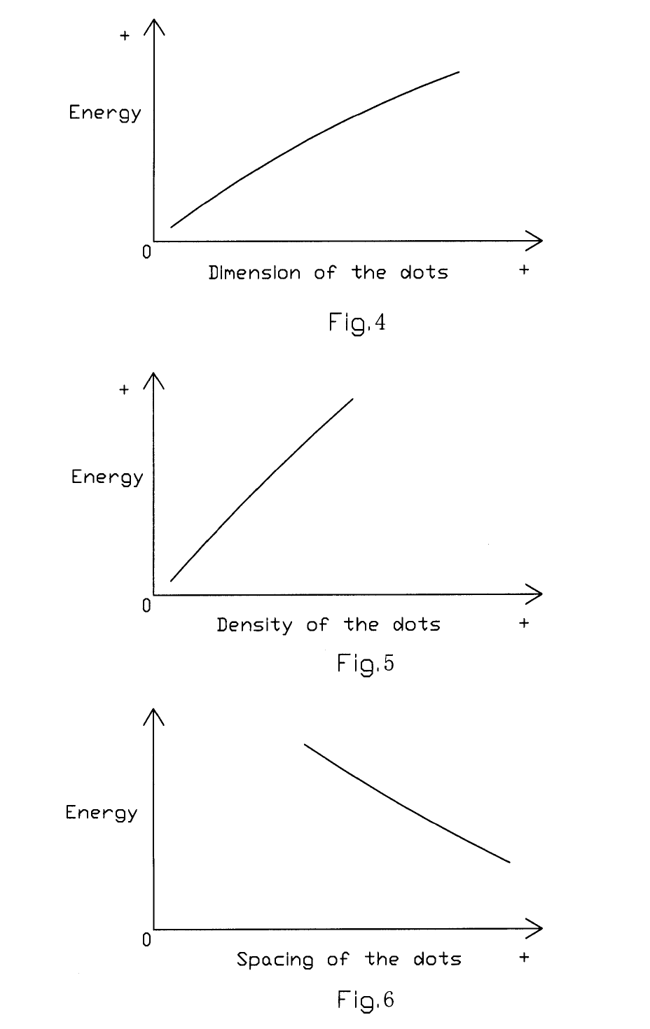

The light transmitted through the light guide plate 3 will lose energy with an increase in transmission distance. This is unavoidable and unfavorable for the light evenness of the light guide plate 3. As the parameters of the dot patterns 31 of the light guide plate 3 have certain relationships with the energy of the light transmitted in the light guide plate 3, focusing on that, the present application provides some improvements. For example, as shown by FIGS. 4 and 5, the dimension and density of the dot patterns 31 are linearly proportional to the light energy. As further shown by FIG. 6, the spacing of the dot patterns 31 is linearly and inversely proportional to the light energy. The following embodiments provide even light distribution and will be described based on these principles.

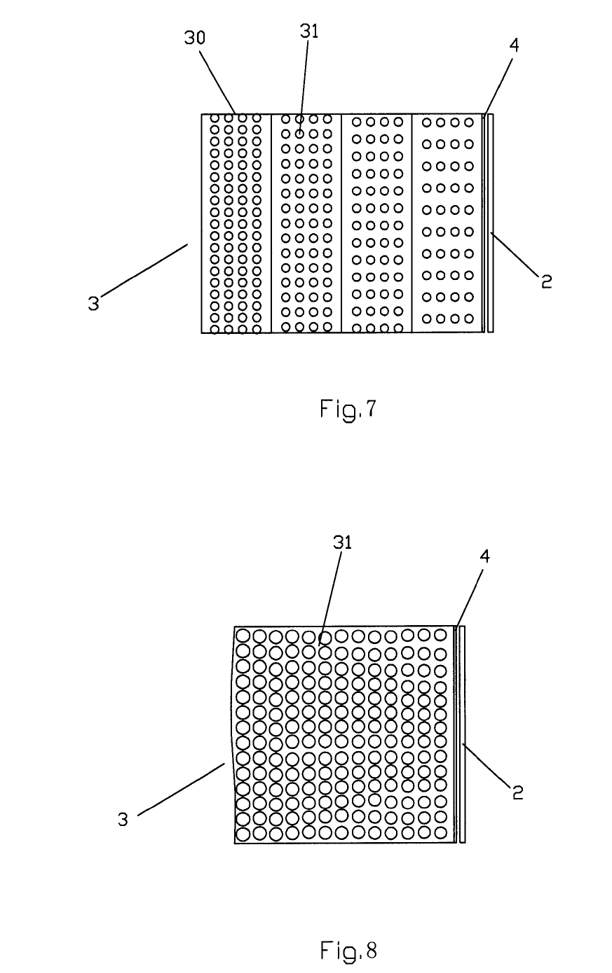

In an embodiment, the dimension of the dot patterns 31 on the light guide plate 3 is proportional to the distance of the mesh point 31 from the light sources 2. As shown in FIG. 7, in order to facilitate production, a design of multiple blocks 30 of the dot patterns 31 is introduced. The dot patterns 31 on the different blocks 30 are different in dimension, density, and spacing. A plurality of blocks 30 are stitched together to form a whole light guide plate 3.

In the production of the light guide plate 3, especially in that of the larger light guide plates, failure of one block 30 will not affect the entire light guide plate, as the one failed will be simply reproduced. This may help manufacturers reduce costs. The dot patterns 31 with a smaller dimension or density, or the blocks 30 with a larger spacing of the dot patterns 31, are arranged more closely to the light sources 2. More specifically, the dot patterns 31 with the smallest dimension or density, or the blocks 30 with the largest spacing of the dot patterns 31 are arranged on the edge of the light guide plate 3, which is the closest position to the light source 2. The dot patterns 31 with larger dimension or density, or the blocks 30 with smaller spacing of the dot patterns 31 are arranged further from the light source 2. This may provide more even lighting, and the whole light guide plate 3 looks more uniform in brightness.

Of course, as shown by FIG. 8, a one piece formed light guide plate 3 can also be used, but one piece light guide plates may only appropriate for the smaller light guide plates. The dot patterns 31 with different dimensions, densities, and spacing are arranged on the light guide plate 3 in basically an increasing or decreasing manner in terms of dimension, density, or spacing, for more even lighting effects.

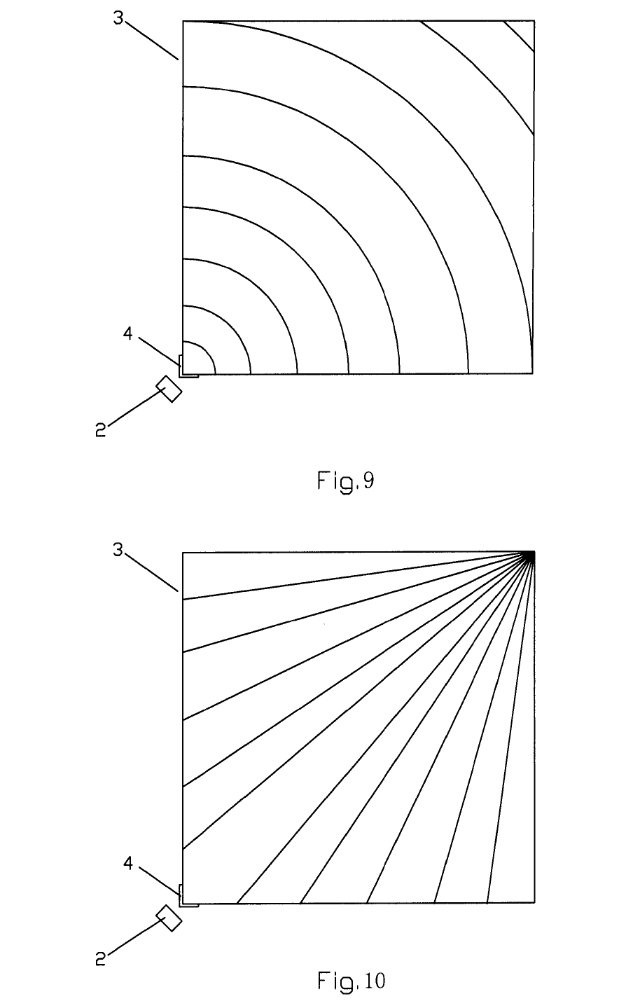

In an embodiment, the distribution of the dot patterns 31 can be determined based on sector to allow the dimension or density of the dot patterns 31 to be proportional to the size of the vector of the dot patterns 31 from the light source 2 or to allow the spacing of the dot patterns 31 to be inversely proportional to the size of the vector of the dot patterns 31 from the light source 2. This can be achieved in a way that, as shown by FIG. 9, for example, if a light source 2 is located on the lateral side of a corner of the light guide plate 3, the light source 2 as the center, and the distances between the different points on the light guide plate 3 and the light source 2 as the radiuses are used to draw circles, whereby the light guide plate 3 is divided into several zones. According to the distances of the zones from the light source 2, and the principles described previously, the dot patterns 31 can be arranged.

Considering that the energy of the front light is greater than the energy of the lateral light of the light sources 2, in the positions with the same distance from the light sources 2, the brightness of the front light is greater than the brightness of the lateral light. Thus, as shown by FIG. 10, based on the differences in angle of the light guide plate 3 with reference to the light source 2, the portion of the light guide plate 3 where the front light is most concentrated is marked as a central zone, and the portions on the two opposite sides of the central zone are divided into a plurality of zones symmetrically. The dot patterns 31 on the central zone have the smallest dimension or density, or the largest spacing, and accordingly increase or decrease by zone, from the center to both sides. This may enable the light guide plate to provide more even lighting.

For lighting devices with a light guide plate used in high-end fields, the efficiency of energy utilization of the light sources 2 may be used to judge performance. The present application provides several embodiments for improving the efficiency of the energy utilization as much as possible.

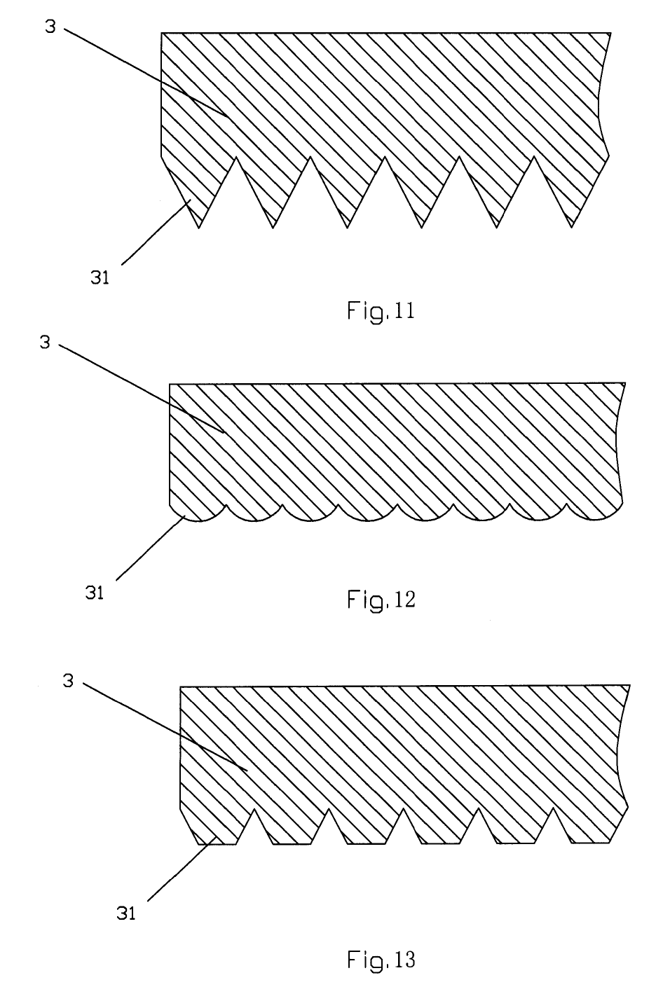

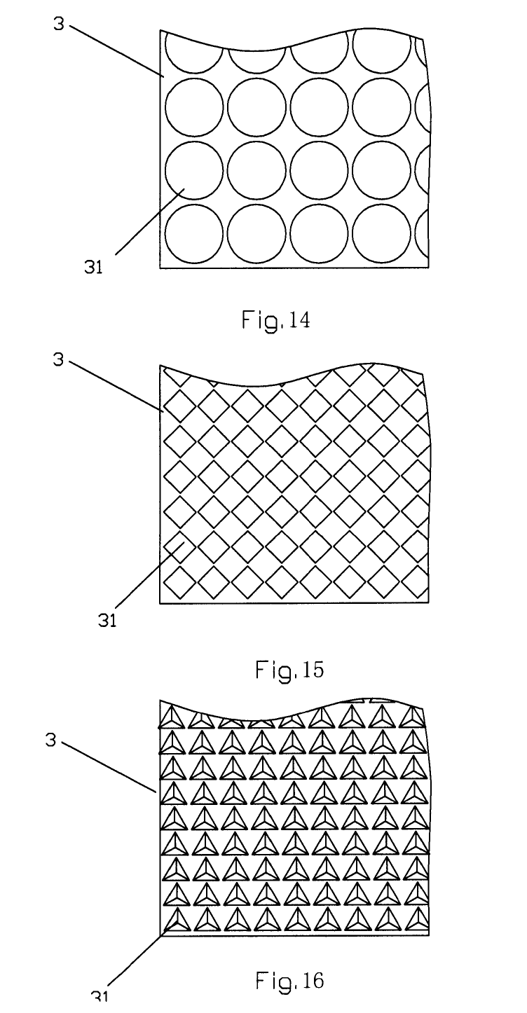

For example, regarding the design of the dot patterns 31 in shape, the array of the strip-like dot patterns 31 with a V-shape cross-section is shown in FIG. 11. The array of the strip-like dot patterns 31 with a cylinder-shape cross-section is shown in FIG. 12. The array of the strip-like dot patterns 31 with a trapezoid-shape cross-section is shown in FIG. 13. The array of the dot patterns 31 in a circle-like micro-lens formation is shown in FIG. 14. The array of the dot patterns 31 in a rectangle-like micro-lens formation is shown in FIG. 15. The array of the dot patterns 31 in a triangle-like or rhombus micro-lens formation is shown in FIG. 16. The above arrangements may help utilize the light energy effectively. However, the dot patterns 31 should not be limited by the formations described above and other suitable formations are possible.

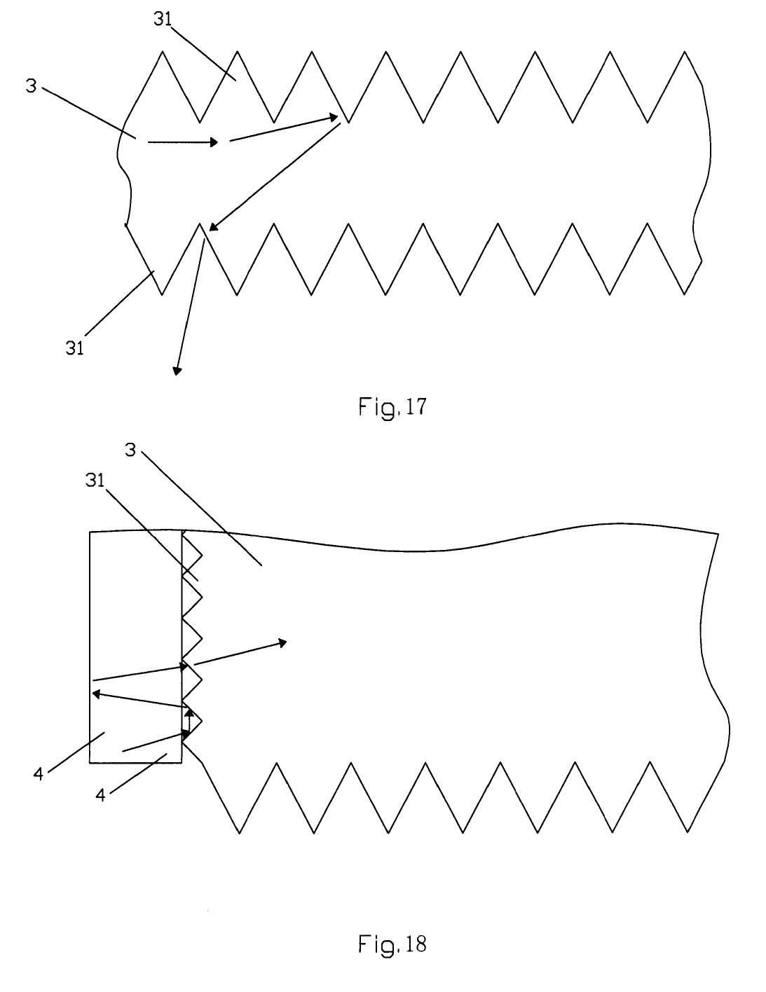

The dot patterns 31 could be arranged on the back side of the light guide plate 3, as shown in FIG. 17. The dot patterns 31 on the back side could play a role in reflecting and refracting the light to achieve double or multiple light refraction for outputting the light from the front side of the light guide plate 3. When used in conjunction with the optical film 5 to help to diffuse the light evenly, this arrangement could provide an extra 7-8% of energy utilization efficiency under some conditions.

As shown by FIG. 18, part of the dot patterns 31 are provided on the lateral side of the light guide plate 3 on which the phosphor 4 is coated. These dot patterns 31 may double or multiply the light reflected by the light guide plate 3 and avoid the light loss caused by the light counteraction of the partial light which goes into the light guide plate 3 through the front side and is reflected back on the original path and the light which just goes in. Thus, under some conditions, the efficiency of light utilization is increased.

While the invention has been described in terms of what are presently considered to be example embodiments, it is to be understood that the invention need not be limited to the disclosed embodiments. Various modifications and similar arrangements included within the spirit and scope of the appended claims which are to be accorded with the broadest reasonable interpretation so as to encompass all such modifications and similar structure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A lighting device with a light guide plate, comprising:
a light guide plate that includes a lateral side through which light enters the light guide plate and that includes a front side through which light exits the light guide plate;
a phosphor that is coated on the lateral side of the light guide plate;
a light source that includes a plurality of light emitting diodes (LEDs) having wavelengths of 230-520 nanometers (nm),
wherein the LEDs are mounted proximate to the lateral side of the light guide plate and corresponding to, but separated from, the phosphor;
a reflector that includes a reflective surface and that is mounted on a back side of the light guide plate with the reflective surface facing the light guide plate; and
a frame that fixes the light guide plate, the light source, and the reflector,
wherein:
colors of the phosphor and the light source are complementary;
the phosphor absorbs light from the light source to transition into an excited state;
the light guide plate receives light from the light source and the phosphor through the lateral side; and
the light guide plate, in conjunction with the reflector, outputs the light from the light source and the phosphor through the front side.

2. The lighting device with light guide plate according to claim 1 wherein the phosphor is one of a tricolor phosphor and a yellow phosphor.

3. The lighting device with light guide plate according to claim 1 wherein the light guide plate includes dot patterns on the back side of the light guide plate.

4. The lighting device with light guide plate according to claim 3 wherein dimension and density of the dot patterns are proportional to a distance of the dot patterns from the light source, the dot patterns with smaller dimension or density are arranged in closer to the light source, while the dot patterns with larger dimension or density are arranged further from the light source.

5. The lighting device with light guide plate according to claim 3 wherein spacing of the dot patterns is inversely proportional to a distance of the dot patterns from the light source.

6. The lighting device with light guide plate according to claim 3 wherein dimension and density of the dot patterns are proportional to a size of a vector of the dot patterns from the light source.

7. The lighting device with light guide plate according to claim 3 wherein the light guide plate further includes dot patterns on the front side of the light guide plate.

8. The lighting device with light guide plate according to claim 3 wherein the light guide plate further includes dot patterns on the lateral side of the light guide plate on which the phosphor is coated.

9. The lighting device with light guide plate according to claim 3 further comprising an optical film that is a diffuser and that is attached to the front side of the light guide plate.

10. The lighting device with light guide plate according to claim 3 further comprising an optical film that is one of a composite material of the diffuser and a brightness enhancement film and that is attached to the front side of the light guide plate.

11. The lighting device with light guide plate according to claim 1 wherein:
a shape of the light guide plate is one of a rectangular shape, a circular shape, and an elliptical shape;
a shape of the frame is annular and is matched to the shape of the light guide plate; and
the light source is fixed on an inner wall of the frame.

12. The lighting device with light guide plate according to claim 1 wherein:
a shape of the light guide plate is one of a rectangular ring shape, a circular ring shape, and an elliptical ring shape;
the frame includes an inner frame and an outer frame;
the outer frame is annular shaped, is matched with an outer edge of the light plate guide, and encloses the outer edge of the light guide plate;
the inner frame is annular shaped, is matched with an inner edge of the light plate guide, and that encloses the inner edge of the light guide plate; and
the light source is fixed on at least one of the outer frame and the inner frame.

13. The lighting device with light guide plate according to claim 12 wherein the frame includes heat dissipation fins on an external surface of the frame proximate to the light source.

14. A lighting device with light guide plate, comprising:
a light guide plate that includes a lateral side through which light enters the light guide plate, that includes a front side through which light exits the light guide plate, and that has one of a rectangular shape, a circular shape, or an elliptical shape;
a phosphor that is coated on the lateral side of the light guide plate;
a light source that includes a plurality of light emitting diodes (LEDs) having wavelengths of 230-520 nanometers (nm), wherein the LEDs are mounted proximate to the lateral side of the light guide plate and corresponding to, but separated from, the phosphor;
a reflector that includes a reflective surface and that is mounted on a back side of the light guide plate with the reflective surface facing the light guide plate and that is matched with the light guide plate in shape; and
a frame that fixes the light guide plate, the light source, and the reflector and that is matched with the light guide plate in shape,
wherein:
colors of the phosphor and the light source are complementary;
the phosphor absorbs light from the light source to transition into an excited state;
the light guide plate receives light from the light source and the phosphor through the lateral side; and
the light guide plate, in conjunction with the reflector, outputs the light from the light source and the phosphor through the front side.

15. The lighting device with light guide plate according to claim 14 wherein the frame includes heat dissipation fins on an external surface of the frame proximate to the light source.

16. A lighting device with light guide plate, comprising:
a light guide plate that includes a lateral side through which light enters the light guide plate, that includes a front side through which light exits the light guide plate, and that has one of a rectangular ring shape, a circular ring shape, and an elliptical ring shape;
a phosphor that coated on at least one of outer and inner sides of the light guide plate;
a light source that includes at least one light emitting diode (LED) having a wavelength of 230-520 nanometers (nm) that is mounted proximate to at least one of the outer and inner sides of the light guide plate corresponding to, but separated from, the phosphor;
a reflector that includes a reflective surface and that is mounted on a back side of the light guide plate with the reflective surface facing the light guide plate and that is matched with the light guide plate in shape; and
a frame that fixes the light guide plate, the light source, and the reflector and that includes an inner frame and an outer frame,
wherein:
the outer frame has an annular shape that is matched with the periphery of the light guide plate and encloses the periphery of the light plate guide;
the inner frame has an annular shape that is matched with an inner edge of the light guide plate and encloses the inner edge of the light guide plate;
colors of the phosphor and the light source are complementary;
the phosphor absorbs light from the light source to transition into an excited state;
the light guide plate receives light from the light source and the phosphor through the lateral side; and
the light guide plate, in conjunction with the reflector, outputs the light from the light source and the phosphor through the front side.

17. The lighting device with light guide plate according to claim 16 wherein the frame includes heat dissipation fins on an external surface of the frame proximate to the light source.
